(19) United States
(12) Patent Application Publication
(10) Pub. No.: US 2019/0141314 A1
(43) Pub. Date: May 9, 2019

(54) STEREOSCOPIC IMAGE DISPLAY SYSTEM AND METHOD FOR DISPLAYING STEREOSCOPIC IMAGES

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW)

(21) Appl. No.: 16/181,289

(22) Filed: Nov. 5, 2018

Related U.S. Application Data
(60) Provisional application No. 62/583,524, filed on Nov. 9, 2017.

(30) Foreign Application Priority Data
Jun. 20, 2018 (TW) 107121040

(51) Int. Cl. H04N 13/305; G02B 27/22; G02B 27/00; H04N 13/207; G06F 3/01; B60R 1/00; B60K 35/00

(52) U.S. Cl. CPC H04N 13/305; G02B 27/2214; G02B 27/0093; B60R 2300/20; G06F 3/013; B60R 1/00; B60K 35/00; H04N 13/207

(57) ABSTRACT

A stereoscopic image display system includes an image capturing module, a processing unit, and a display device including a lens module. The processing unit is configured to perform the following instructions. A facial feature is identified from based on a facial image of a viewer, and a left eye position and a right eye position are computed. A left eye viewing vector and a right eye viewing vector are computed based on the left eye position and the right eye position, respectively. A left eye view and a right eye view are generated based on the left eye viewing vector and the right eye viewing vector, respectively. An image fusion processing is performed on the left eye view and the right eye view to render a fused image. The fused image is projected to a left eye and a right eye of the viewer via the lens module.

### Cross Reference To Related Applications

This patent application claims the benefit of U.S. provisional patent application Ser. No. 62/583,524, which is filed on Nov. 9, 2017, and incorporated herein by reference in its entirety.

### BACKGROUND OF THE INVENTION

### 1. Field of the Invention

The invention relates to a display system and a method, and more particularly, to a stereoscopic image display system and a method for displaying stereoscopic images which vary with a viewer's sightline.

### 2. Description of the Prior Art

Human's field of view has a limited range of visual field (including a horizontal visual angle and a vertical range visual angle). To expand visual fields, we have to constantly change viewing angles as well as viewing directions. For example, assuming a vehicle is parked in front of a viewer in the real world, from the place where the viewer stands, he/she may only see the front side of the car because of the limited scope of the field of view. However, when the viewer moves the position to the right where he/she can view the same vehicle from the right (to the left), the viewer can therefore see a partial front side and a partial lateral side of the vehicle car. That is, by changing the viewing angle and direction the field of view can be expanded indefinitely in the real world.

Nonetheless, the situation would be different when it comes to images displayed on a display device. Given the limited size of display devices, images can only be presented in conforming with the size of a display device. Consequently, the information can be displayed is also restricted.

Besides, conventional display adopts a perspective transform to compress a 3D object into a 2D format. However, images presented on conventional screens are static. That is, an image remains unchanged no matter where the viewer is. The viewing experience is different to that in the real world.

### SUMMARY OF THE INVENTION

According to one aspect of the present disclosure, a stereoscopic image display system is provided. The stereoscopic image display system includes an image capturing module, a processing unit, and a display device. The image capturing module is configured to capture a facial image of a viewer. The processing unit is coupled to the image capturing module and configured to perform the following instructions. A facial feature is identified based on the facial image, and a left eye position and a right eye position are computed. A left eye viewing vector and a right eye viewing vector are computed based on the left eye position and the right eye position, respectively. A left eye view is generated based on the left eye viewing vector. A right eye view is generated based on the right eye viewing vector. An image fusion processing is performed on the left eye view and the right eye view to render a fused image. The display device is coupled to the processing unit and including a lens module. The fused image is projected to a left eye of the viewer and a right eye of the viewer via the lens module.

According to another aspect of the present disclosure, another stereoscopic image display system is provided. The stereoscopic image display system includes an image capturing module, a processing unit, and a display device. The image capturing module is configured to capture a first facial image of a viewer at a first time and a second facial image of the viewer at a second time. The processing unit is coupled to the image capturing module and configured to perform the following instructions. A first facial feature is identified based on the first facial image, and a first left eye position and a first right eye position are computed. A first left eye viewing vector and a first right eye viewing vector are computed based on the first left eye position and the first right eye position, respectively. A first left eye view is generated based on the first left eye viewing vector. A first right eye view is generated based on the first right eye viewing vector. An image fusion processing is performed on the first left eye view and the first right eye view to render a first fused image. A second facial feature is identified based on the second facial image, and a second left eye position and a second right eye position are computed. A second left eye viewing vector and a second right eye viewing vector are computed based on the second left eye position and the second right eye position, respectively. A second left eye view is generated based on the second left eye viewing vector. A second right eye view is generated based on the second right eye viewing vector. The image fusion processing is performed on the second left eye view and the second right eye view to render a second fused image. The display device is coupled to the processing unit and including lens module. The first fused image is projected to a left eye and a right eye of the viewer via the lens module at the first time, and the second fused image is projected to the left eye and the right eye of the viewer via the lens module at the second time.

According to a yet another aspect of the present disclosure, a method for displaying stereoscopic images is provided. The method includes the following instructions. A facial image of a viewer is captured at a first time. A facial feature is identified based on the facial image and a left eye position and a right eye position are computed. A left eye viewing vector and a right eye viewing vector are computed based on the left eye position and the right eye position, respectively. A left eye view is generated based on the left eye viewing vector. A right eye view is generated based on the right eye viewing vector. An image fusion processing is performed on the left eye view and the right eye view to render a first fused image. The fused image is projected to a left eye and a right eye of the viewer via a lens module at the first time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system implemented in an intelligent car according to an embodiment of the present disclosure.

FIG. 2 is a functional block diagram of a display system according to an embodiment of the disclosure.

FIG. 3 is a schematic diagram illustrating a viewer and the display system according to a first embodiment of the present disclosure.

FIG. 4 is a schematic diagram of a facial image of the viewer captured by the processing unit according to the first embodiment of the present disclosure.

FIG. 5 is a schematic diagram of a facial feature of the viewer according to the first embodiment of the present disclosure.

FIG. 6 is a schematic diagram illustrating the relative position of the viewer, the image capturing module and the object according to the first embodiment of the present disclosure.

FIG. 7 is a schematic diagram illustrating a left eye view and a right eye view according to the first embodiment of the present disclosure.

FIG. 8 is a schematic diagram illustrating a fused image generated in response to a left eye view and a right eye view of the object according to the first embodiment of the present disclosure.

FIG. 9 is a flowchart of a method for displaying images on a display system according to the first embodiment of the present disclosure.

FIG. 10 is a schematic diagram of the two facial images of the viewer captured by the processing unit according to a second embodiment of the present disclosure.

FIG. 11 is a schematic diagram illustrating the relative position of the viewer and the object when the viewer is at the second position according to the second embodiment of the present disclosure.

FIG. 12 is a schematic diagram illustrating the generation of the second left eye view and the second right eye view according to the second embodiment of the present disclosure.

FIG. 13 is a schematic diagram illustrating a second fused image generated in response to a second left eye view and a second right eye view of the object according to the second embodiment of the present disclosure.

FIGS. 14A-14C are schematic diagrams of three displayed images displayed by a display system according to different sightlines of the viewer according to an embodiment of the present disclosure.

FIGS. 15A and 15B are flowcharts of a method for displaying images on a display system according to the second embodiment of the present disclosure.

FIG. 16 is a schematic diagram of the display system according to a third embodiment of the present invention.

FIG. 17 is a schematic diagram of a lens module according to the third embodiment of the present disclosure.

FIG. 18 is a schematic diagram illustrating a projection of an interlaced fused image via the lens module according to the third embodiment of the present disclosure.

FIG. 19 is a schematic diagram illustrating an implementation of a projection of the interlaced fused image via the lens module 34 according to the third embodiment of the present disclosure.

FIG. 20 is a flowchart of a method for displaying images on the display system according to the third embodiment of the present disclosure.

### DETAILED DESCRIPTION

In the present disclosure, a display system and a method for displaying images on a display system are provided to generate a displayed image according to a sightline of a viewer. Via the display system, an appearance of the object presented to the viewer may vary with the sightline of the viewer as if the object was observed in the real world, which gives the viewer a more realistic user experience. In addition, various displayed images may be provided according to various sightlines of the viewer so as to expand the field of view of the viewer.

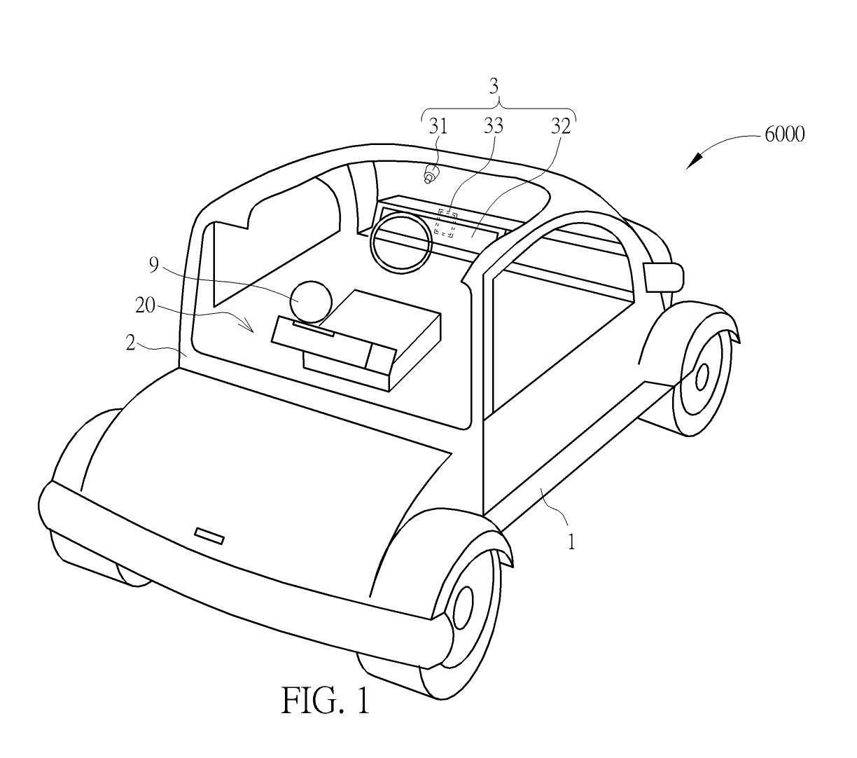

FIG. 1 is a schematic diagram of a display system 3 implemented in an intelligent car 6000 according to an embodiment of the present disclosure. The intelligent car 6000 includes a chassis 1, a car frame 2, and the display system 3 . The car frame 2 is disposed on the chassis 1, and has a cabin 20 for the driver and passengers. It should be noticed that, in some other embodiments, the display system may be implemented in any apparatus, such as a portable device.

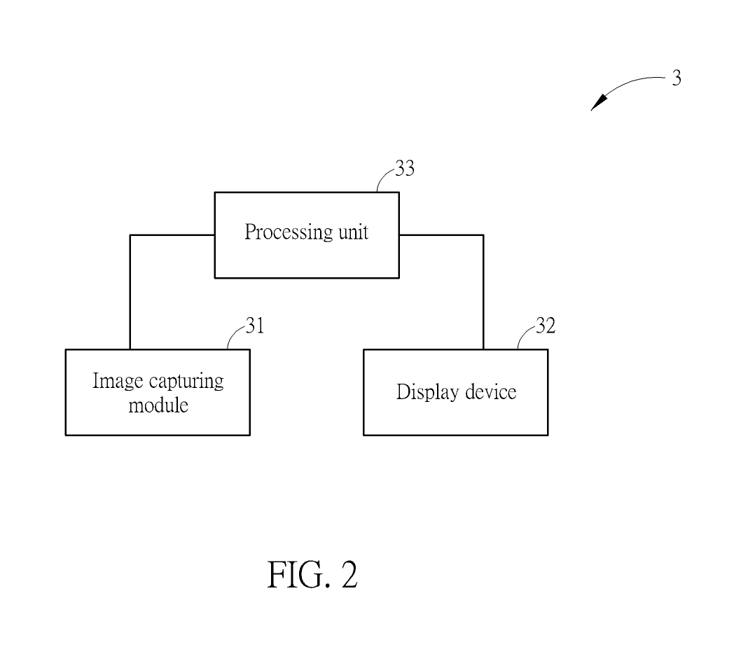

FIG. 2 is a functional block diagram of a display system 3 according to an embodiment of the present disclosure. As shown in FIG. 2, the display system 3 includes an image capturing module 31, a display device 32 and a processing unit 33. In this embodiment, the display system. 3 is implemented in an intelligent car (e.g., 6000 as shown in FIG. 1). The image capturing module 31 may be disposed inside a car (e.g., in a cabin 20 as shown in FIG. 1). The image capturing module 31 is configured to capture a viewer's facial images. In one implementation, the image capturing module 31 may be, but not limited to, a camera or any device capable of capturing images.

The display device 32 is disposed inside the cabin 20. The display device is configured to display a fused image. The display device 32 may be, but not limited to, a digital vehicle instrument cluster, a central console panel, or a head-up display.

The processing unit 33 is coupled to the image capturing module 31 and the display device 32. The processing unit 33 may be an intelligent hardware device, such as a central processing unit (CPU), a microcontroller, or an ASIC. The processing unit 33 may process data and instructions. In this embodiment, the processing unit 33 is an automotive electronic control unit (ECU). The processing unit 33 is configured to identify a facial feature based on the facial image captured by the image capturing module 31, generate a left eye view and a right eye view, and perform image fusion processing on the left eye view and the right eye view to render a fused image.

As previously mentioned, conventional display devices present images dully. An image displayed on a conventional displayer will not change in any viewing direction. From viewers' perspective, the field of view with respect to the common displayer is constant. On the other hand, the fused image provided in accordance with the instant disclosure may change with different viewpoints of a viewer. Therefore, a field of view of the viewer may be expanded even though the display area is fixed.

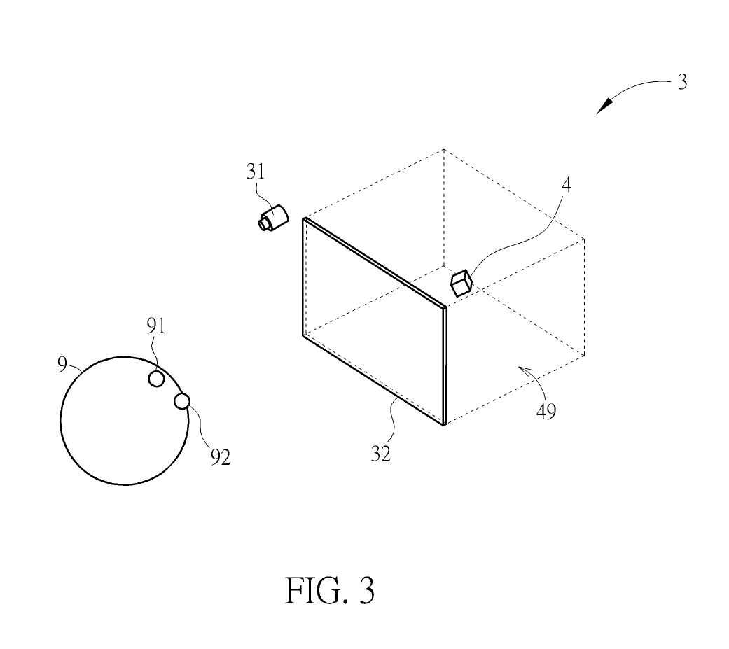

FIGS. 3-8 are schematic diagrams illustrating an operation of the display system 3 according to an implementation of the present disclosure. The method for displaying images on the display system 3 are described as follows with reference to FIGS. 1-8. FIG. 3 is a schematic diagram illustrating a viewer and the display system according to a first embodiment of the present disclosure. In this implementation, a viewer (e.g., the driver 9) is seated in a cabin 20 of the intelligent car 6000, and his/her head 9 faces toward the display system 3 . The image capturing module 31 and the display device 32 are disposed in front of the viewer and facing toward the viewer, and the viewer may observe an image displayed by the display device 32. As shown in FIG. 3, a three-dimensional (3D) object 4, such as a cube, is displayed on the display device 32. Specifically, the displayed image of the object 4 provided by the display system 3 may change with different viewpoints sightlines of the viewer, and the display device 32 provides a visual effect that the 3D object 4 is located in a 3D virtual space 49 extending from the display device 32. Therefore, the display device 32 may present an image of the 3D object 4 to the viewer as a real object in a 3D space even though the display device 32 is a flat display device. In addition, a corresponding part of the object 4 is presented on the display device 32 according to the sightlines of the viewer. As such, instead of performing a perspective transform to compress a 3D virtual object into a 2D format, the display system 3 displays a fused image combining the left eye view and the right eye view to preserve the graphic information of the object 4 without data loss or distortion.

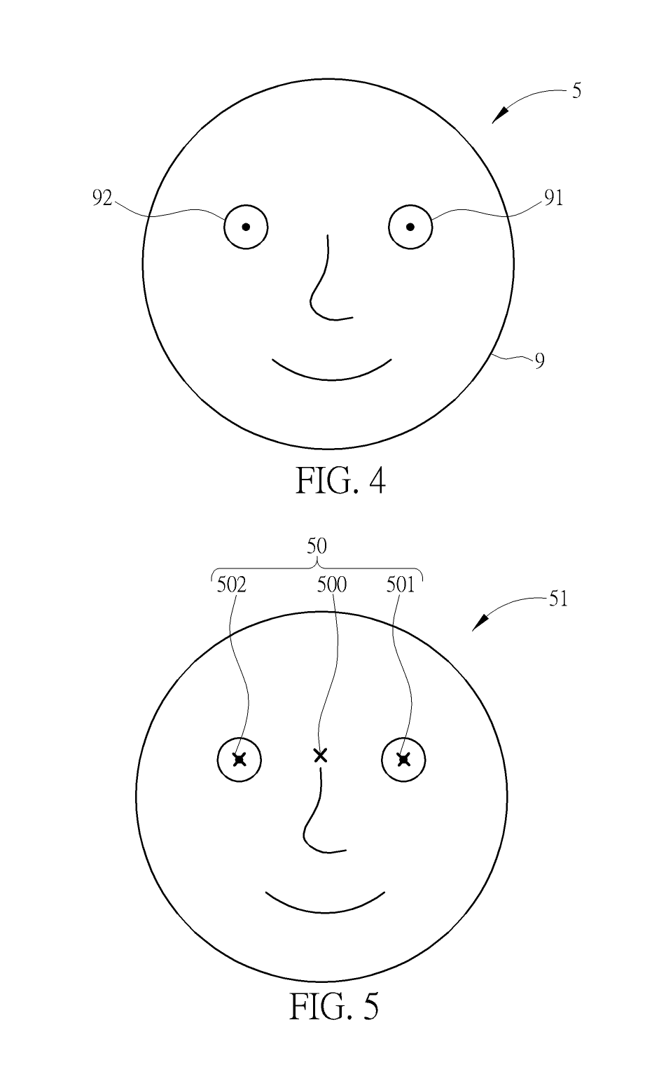

Firstly, a facial image of the viewer is captured by the image capturing module 31. FIG. 4 is a schematic diagram of a facial image 5 of the viewer captured by the image capturing module 31. As shown, the facial image 5 at least includes a left eye 91 and right eye 92.

Based on the facial image 5, a facial feature 50 is identified by the processing unit 33. That includes computations of a left eye position and a right eye position. The facial feature 50 may be identified via computations of image recognition and image processing familiar by skilled persons. Alternatively, the processing unit 33 may establish a facial model 51 before identifying the facial feature 50. FIG. 5 shows a facial model 51 corresponding to the captured facial image 5. In one embodiment, the facial feature 50 includes a left eye region and a right eye region. In some embodiments, the facial feature 50 further includes a head position 500 (e.g., a middle point between the eyes, or a nose tip). In yet another embodiment, the facial feature 50 further includes a head pose. The head pose includes an angle of yaw rotation, an angle of pitch rotation and an angle of a roll rotation. In some embodiments, the facial feature 50 further includes an eye gesture, which is determined, for instance, by the positions of the pupils, the positions of eyelids.

According to the identified facial feature, a coordinate system is established by the processing unit 33, where an origin of the coordinate system may be set at any point. The coordinate system is referenced when it comes to relative positions of, for instance, without limitation, the viewer 9, the object 4, the image capturing module 31, the displaying display device 32, etc. In one instance, it may be set in light of the virtual space 49. For example, the origin may be set at a point (e.g., a center of mass or a center of volume) of the displayed object 4, or the center of the virtual space 49. In this implementation, the origin of the coordinate system is set at the center of the object.

The position of the viewer is obtained and recorded with reference to the coordinate system. The processing unit 33 obtains the position (e.g., a head position or an eye position) of the viewer using 3D sensing technologies. For instance, the image capturing module 31 is a stereo camera (with two or more lens) used for obtaining the position of the viewer. In some other implementations, the image capturing module 31 includes a depth sensor used for obtaining the position of the viewer.

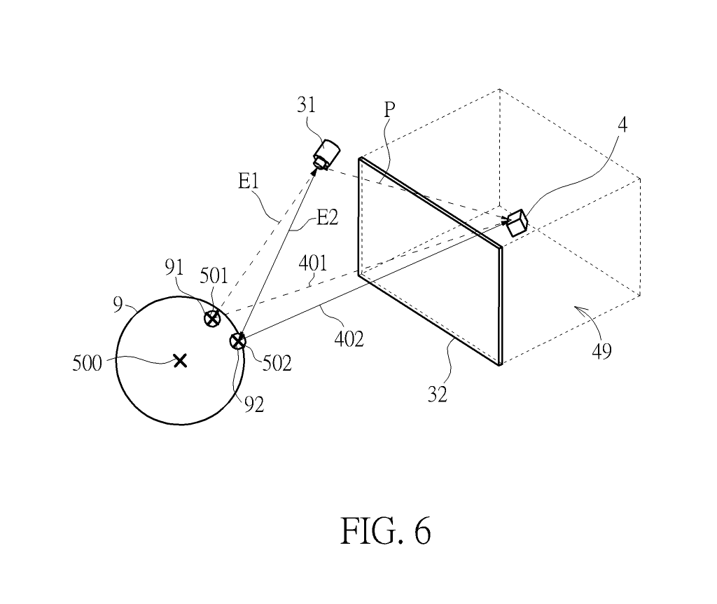

FIG. 6 is a schematic diagram illustrating the relative positions of the viewer 9, the image capturing module 31 and the object 4 with reference to the coordinate system. Since the image capturing module 31 is a fixture inside the cabin 20, as shown in FIG. 1, a position of the image capturing module 31 is known and invariant. A position of the object 4 inside the virtual space 49 is also known to the processing unit 33. Therefore, based on the positions of the image capturing module 31 and the object 4, a position vector P from the position of the image capturing module 31 to the position of the object 4 is computed.

A left eye position vector E1 and a right eye position vector E2 are calculated. The left eye position vector E1 from the left eye position 501 to the image capturing module 31 is computed based on the position of the viewer and the left eye position 501. The right eye position vector E2 from the left eye position 502 to the image capturing module 31 is computed based on the position of the viewer and the left eye position 502.

Next, the sightline of the viewer to the display device 32 is determined. The sightline (including a gaze direction and a gaze angle) of the viewer may be represented by a left eye viewing vector 401 and a right eye viewing vector 402. Based on the position vector P, the left eye position vector E1 and the right eye position vector E2, the processing unit 33 computes the left eye viewing vector 401 from the left eye position 501 to the object 4 and the right eye viewing vector 402 from the right eye position 502 to the object 4. In this embodiment, the first left eye position 501 and the first right eye position 502 of the viewer is utilized to determine the sightline of the viewer.

In some embodiments, the head position 500 identified based on the facial features 50 of the viewer is used to determine the sightline of the viewer. In yet another embodiment, the head pose identified based on the facial features 50 is used to determine the sightline of the viewer. In some embodiments, the eye gesture identified based on the facial features 50 is used to determine the sightline of the viewer. In some other embodiments, other facial features are used to determine the sightline of the viewer.

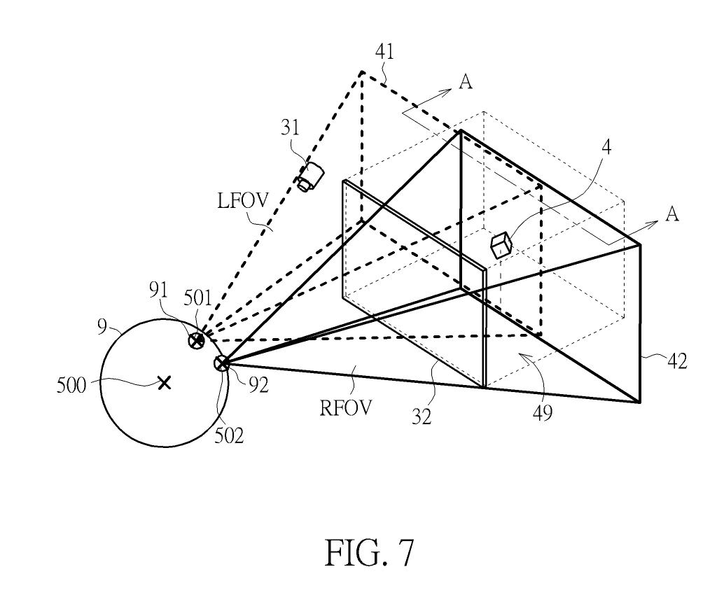

After the sightline of the viewer (i.e., the left eye viewing vector 401 and the right eye viewing vector 402) is determined, a left eye view and a right eye view are generated. FIG. 7 is a schematic diagram illustrating a left eye view 41 and a right eye view 42. As shown in FIG. 7, a left eye view 41 (shown as the dotted line) is generated based on the left eye viewing vector 401, and the right eye view 42 (shown as the solid line) is generated based on the right eye viewing vector 402. For instance, a left field of view LFOV (shown as the pyramid defined by the dotted line) is generated by expanding a field of view (FOV) of the human eyes along the left eye viewing vector 401. Similarly, aright field of view RFOV (shown as the pyramid defined by the solid line) is generated by expanding the FOV of the human eyes along the right eye viewing vector 402. In response to a plane where the object 4 is situated (that is, the depth of the object 4), the left field of view LFOV and the right field of view RFOV generate a left eye view 41 (shown as the base of the dotted-lined pyramid) and a right eye view 42 (shown as the base of the solid-lined pyramid), respectively.

In the real world, the vision of the left eye of the human may not be exactly identical to the vision of the right eye of the human. Specifically, when an object is being observed, the left eye captures more information about a left side of the object, while the right eye captures more information about a right side of the object. In the present disclosure, all graphic information of the object observed by the left eye and the right eye will be preserved. To provide the viewer with a more realistic visual effect, the display system 3 of the present disclosure generates two images each containing the graphic information corresponding to the left eye and the right eye according to the left eye position and the right eye position, respectively, and then perform image fusion processing on integrate all the graphic information into one fused image. In contrast to conventional display system that provides an image corresponding only to a single sightline, the display system of the present disclosure displays a more realistic image, and therefore improves the visual experience of the viewer.

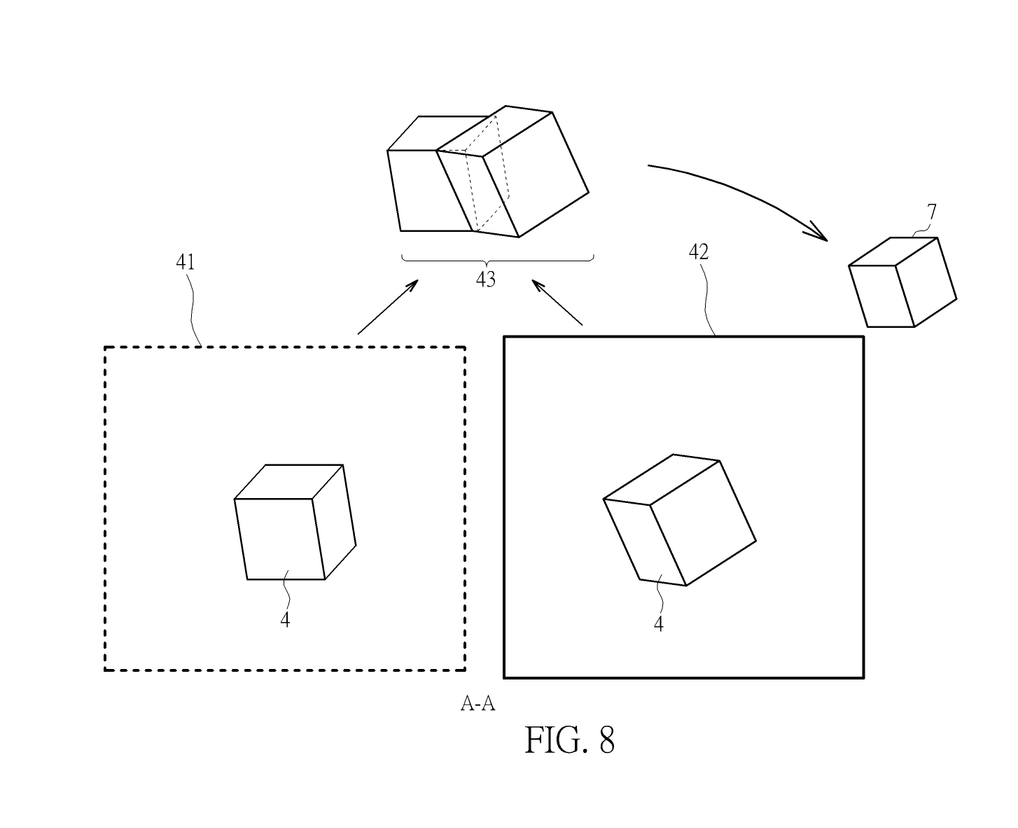

FIG. 8 is a schematic diagram illustrating how a fused image 7 generated in response to a left eye view 41 and a right eye view 42 of the object 4. As shown in FIG. 8, the left eye view 41 and the right eye view 42 include different graphic information of the same object 4. For instance, the left eye view 41 is regarded as graphic information captured solely by the left eye, and the right eye view 42 is regarded as graphic information captured solely by the right eye. The left eye view 41 and the right eye view 42 overlap with each other to form an overlapping region 43. Besides, other than the overlapping region 43, the left eye view 41 further includes left graphic information of the object 4, while the right eye view 42 further includes right graphic information of the object 4. In one embodiment, the processing unit 33 performs image fusion processing on the graphic information of both the left eye view 41 and the right eye view 42 in the overlapping region 43, and then performs image fusion processing on the left graphic information, the right graphic information, and the fused graphic information in the overlapping region 43 to render a fused image 7. In another embodiment, the processing unit 33 directly performs image fusion processing on the left eye view 41 and the right eye view 42 to render the fused image 7. After the abovementioned image fusion processing is completed, the display device 32 displays the fused image 7.

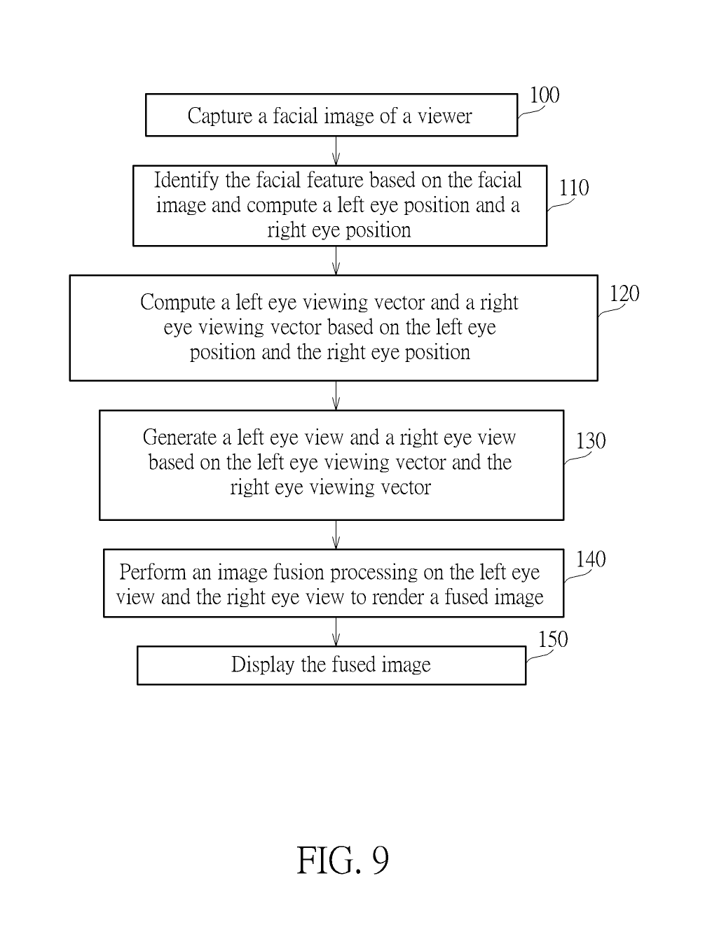

FIG. 9 is a flowchart showing a method of displaying images on a display system according to the first embodiment of the present disclosure. The method utilizes an image capturing module and a processing unit to render and display an image of an object according to the sightline of the viewer. The method is described with reference to FIGS. 3-8. The method includes the following actions.

In action 100, as shown in FIG. 4, a facial image 5 of the viewer is captured by an image capturing module 31.

In action 110, as shown in FIG. 5, a facial feature 50 is identified, by the processing unit 33, based on the facial image 5; a left eye position 501 and a right eye position 502 are consequently computed.

In action 120, as shown in FIG. 6, a left eye viewing vector 401 and a right eye viewing vector 402 are computed, by the processing unit 33, based on the left eye position 501 and the right eye position 502.

In action 130, as shown in FIG. 7, a left eye view 41 and a right eye view 42 are generated, by the processing unit 33, based on the left eye viewing vector 401 and the right eye viewing vector 402, respectively; where the left eye view 41 is a view observed solely by the viewer's left eye, the right eye view 42 is a view observed solely by the viewer's right eye; and the left eye view 41 and the right eye view 42 have an overlapping region 43 (as shown in FIG. 8). In addition, the left eye view 41 includes a left graphic information of the object 4, and the right eye view includes a right graphic information of the object 4.

In action 140, as shown in FIG. 8, an image fusion processing is performed, by the processing unit 33, on the left eye view 41 and the right eye view 42 to render a fused image 7.

In action 150, the fused image 7 is displayed on the display device 32.

Through the abovementioned actions, the method for displaying images on a display system of the present disclosure may track the direction and the angle of the viewer's sightline based on the positions of the viewer's left eye and right eye and then renders an image of the object according to the viewer's sightline. Moreover, the sightline of the viewer may be tracked according to a head position, a head pose, an eye gesture, or other facial features of the viewer. As mentioned before, when a conventional display device displays an image of an object, the displayed image of the object is static and identical to the viewer at any viewpoint. In contrast, the display system of the present disclosure renders the displayed image according to the direction and the angle of the viewer's sightline so that the displayed object may be presented as if the object is observed in the real world. For example, if the sightline of the viewer shifts to view the object from a left top side to the right bottom side, a left top side of the object is displayed by the display device 32 as if the object is observed from a left top position.

Furthermore, in the present disclosure, a left eye view and the right eye view are generated based on the position of the viewer and then the image fusion processing is performed on the left eye view and the right eye view to render a fused image. Therefore, by implementation of the parallax between the left and right eyes, the displayed object 4 looks more realistic.

Besides, a range of vision may be extended. As mentioned above, the left eye captures graphic information that is outside the field of view of the right eye, and vice versa. in the present disclosure, all graphic information including the left graphic information and the right graphic information are preserved so that all the graphic information may be presented to the viewer according to the direction and the angle of the viewer's sightline. Therefore, the displayed image may vary with the viewer's sightline, and more contents of the object may be displayed though the position and the size of the display device 32 are fixed and limited, and thus the range of vision may be extended.

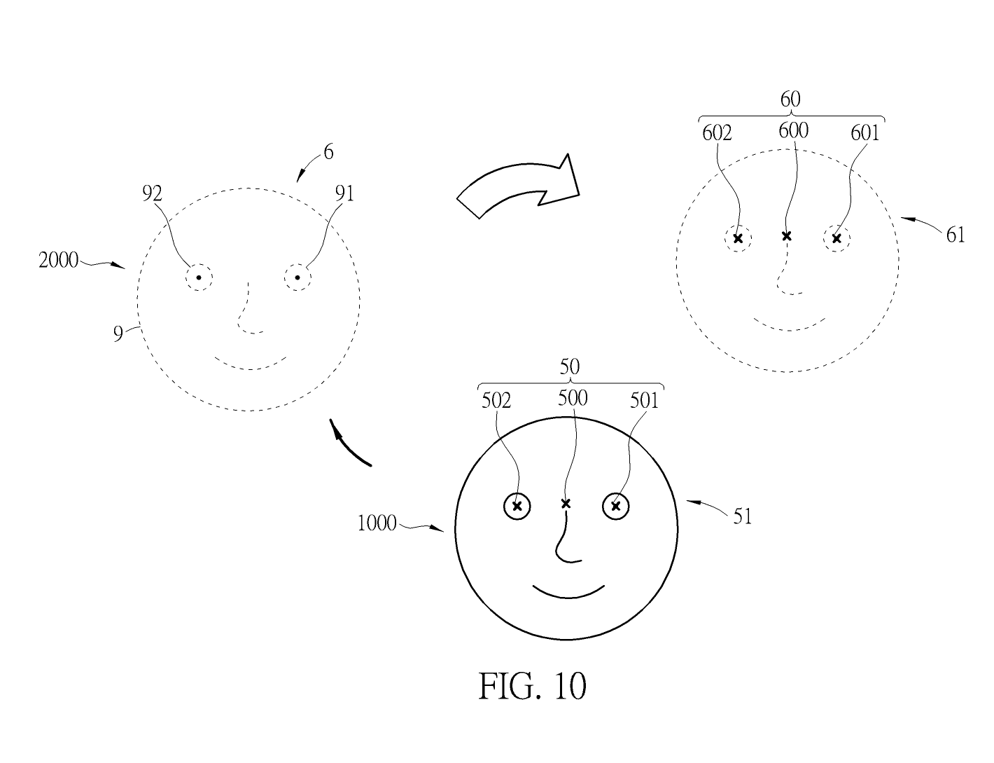

In another embodiment, a display system and method for displaying images are provided for displaying various graphic information or images corresponding to various viewpoints of the viewer so as to expand the field of view. The display system and the method are described as follows with reference to FIGS. 10-15B. In this embodiment, the display system not only presents a first displayed image according to a sightline of the viewer at a first position at a first time, but also presents a second displayed image according to a sightline of the viewer at a second position at a second time after the viewer shifts to the second position at the second time. In other words, the displayed image is changed when the viewer's sightline is changed. Further detailed description about the method for displaying images is introduced as follows.

FIG. 10 is a schematic diagram of the two facial images of the viewer captured by the processing unit 33. First, as shown in FIG. 10, a first facial image 5 of the viewer at the first position 1000 is captured at the first time. As discussed before, the facial image 5 includes a left eye region and a right eye region. It is noted that the process of generating the first fused image corresponding to the first position 1000 of the viewer at the first time is the same as described with reference to FIGS. 3-8, and the relative description is omitted here.

When the viewer shifts from the first position 1000 to the second position 2000 at the second time, a second facial image 6 of the viewer at the second position 2000 is captured by the image capturing module 31. Similarly, the second facial image 6 includes a left eye 91 and a right eye 92. Next, a second facial feature 60 is identified by the processing unit 33 based on the second facial image 6. In one embodiment, the second facial features 60 includes a second left eye position 601 and a second right eye position 602. In one implementation, the processing unit 33 may establish a second facial model 61 before identifying the second facial feature. In another embodiment, the second facial feature 60 further includes the head position 600. In yet another embodiment, the facial feature 60 further includes a head pose. In some embodiments, the facial feature 60 further includes an eye gesture.

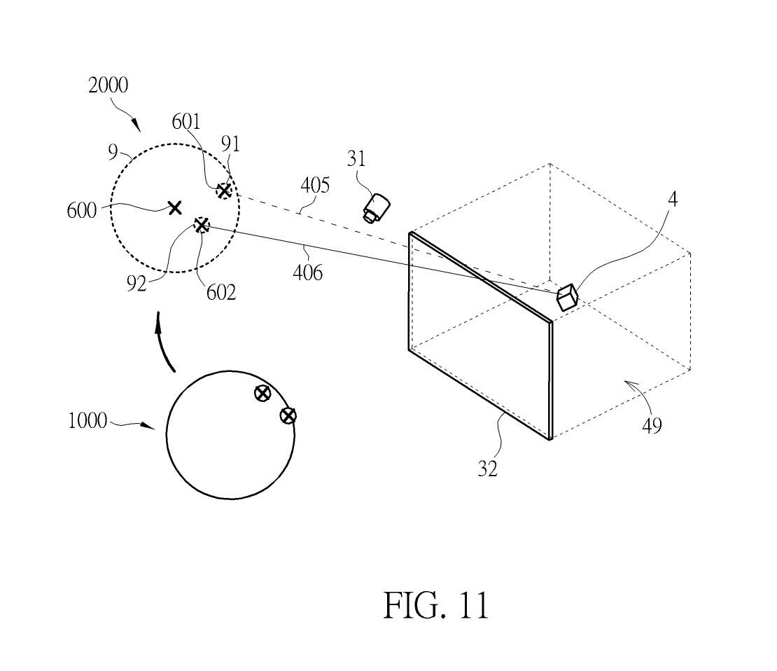

According to the identified facial feature, a second left eye position 601 and a second right eye position 602 are computed. FIG. 11 is a schematic diagram illustrating the relative position of the viewer 9 and the object 4 when the viewer is at the second position. As shown in FIG. 11, the processing unit 33 computes a second left eye viewing vector 405 from the second left eye position 601 to the object 4 and a second right eye viewing vector 406 from the second right eye position 602 to the object 4 based on the second left eye position 601 and the second right eye position 602, respectively.

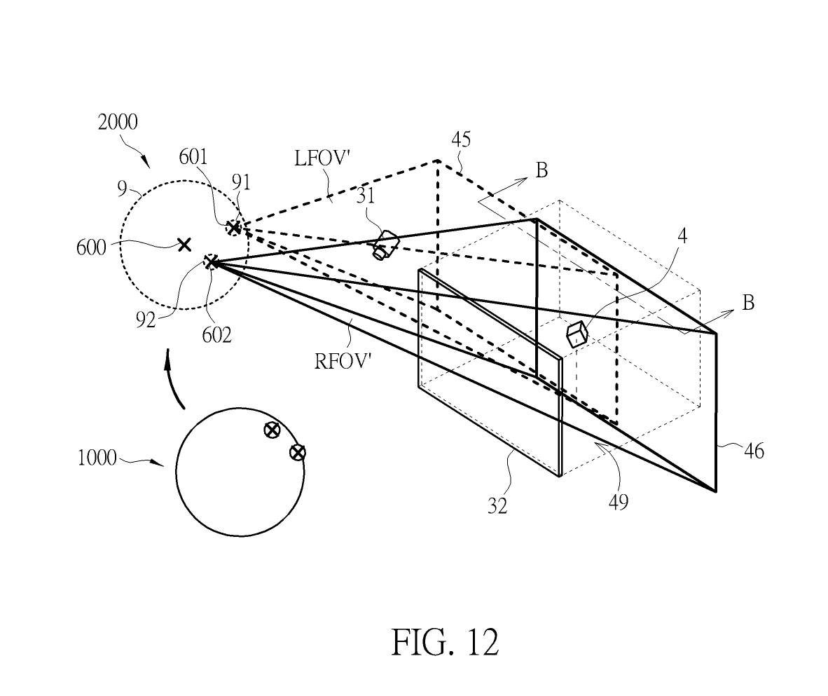

After the second left eye viewing vector 405 and the second right eye viewing vector 406 are computed, a second left eye view and a second right eye view are generated. FIG. 12 is a schematic diagram illustrating the generation of the second left eye view 45 and the second right eye view 46. As shown in FIG. 12, a second left field of view LFOV′ (shown as the pyramid defined by the dotted line) is generated by expanding a field of view (FOV) of the human eyes along the second left eye viewing vector 405, and a second right field of view RFOV′ (shown as the pyramid defined by the solid line) is generated by expanding the FOV of the human eyes along the second right eye viewing vector 406. The second left field of view LFOV′ corresponds to a second left eye view 45, and the second right field of view RFOV′ corresponds to a second right eye view 46.

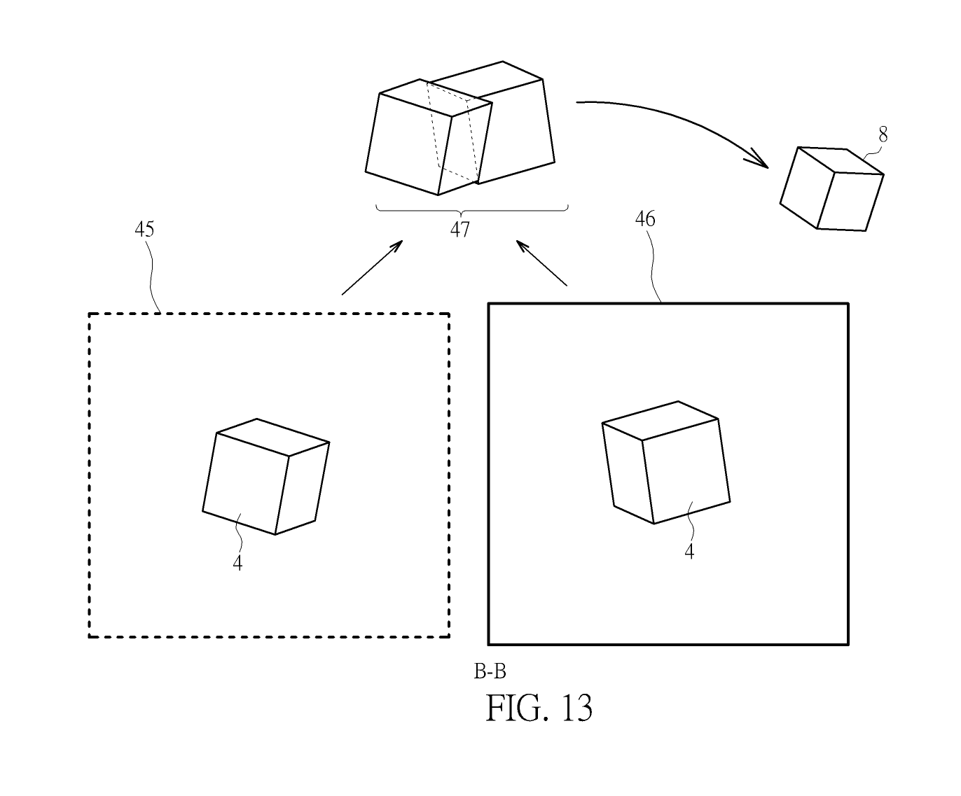

FIG. 13 is a schematic diagram illustrating a second fused image 8 generated in response to a second left eye view 45 and a second right eye view 46 of the object 4. As shown in FIG. 13, the second left eye view 45 is regarded as graphic information captured solely by the left eye, and the second right eye view 46 is regarded as graphic information captured solely by the right eye. The second left eye view 45 and the second right eye view 46 overlap with each other to form a second overlapping region 47. Besides, other than the overlapping region 47, the second left eye view 45 further includes second left graphic information of the object 4, while the second right eye view 46 further includes second right graphic information of the object 4. In one embodiment, the processing unit 33 performs image fusion processing on the graphic information of both the second left eye view 45 and the second right eye view 46 in the overlapping region 47, and then performs image fusion processing on the second left graphic information, the second right graphic information, and the fused graphic information in the overlapping region 47 to render a fused image 8. In another embodiment, the processing unit 33 can directly performs image fusion processing on the second left eye view 45 and the second right eye view 46 to render the second fused image 8. After the abovementioned image fusion processing is completed, the display device 32 displays the second fused image 8.

Based on the above, no matter where the viewer is, the display system of the present disclosure utilizes the abovementioned process to generate the left eye view corresponding to the viewer's left eye and the right eye view corresponding to the viewer's right eye and then perform image fusion processing on the two views to render a displayed image corresponding to the viewer's sightline. In addition, a displayed image observed by the viewer at the first position 1000 is different from a displayed image observed by the viewer at the second position 2000. That is, the display system of the present disclosure displays different parts of an object in response to the viewer's sightline, which could be related to the real-life experience that a viewer changes the location to observe an object thoroughly. For example, when the viewer at the first position 1000 in front of and facing towards the display device observes an object displayed by the display device, the viewer sees a front side of the object. When the viewer shifts the sightline left (that is, viewing the display device from the right), the viewer observes more information on the right side of the object. When the viewer shifts the sightline right (that is, viewing the display device from the left), the viewer observes more information on the left side of the object.

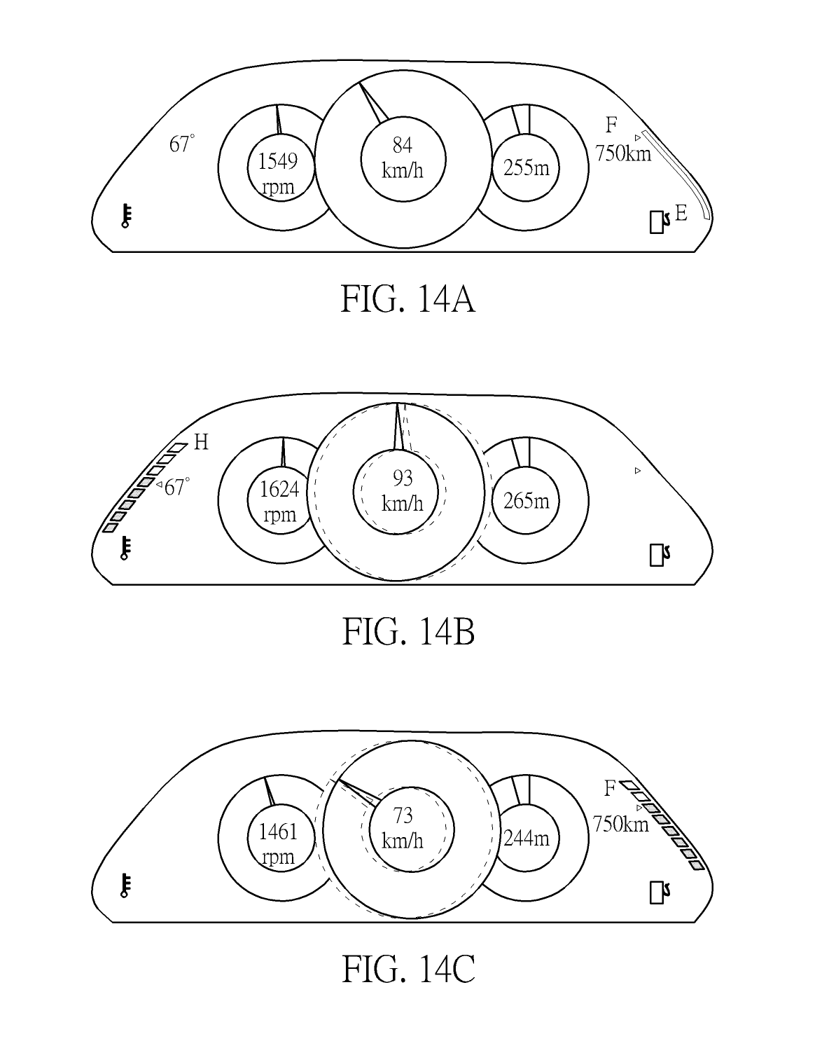

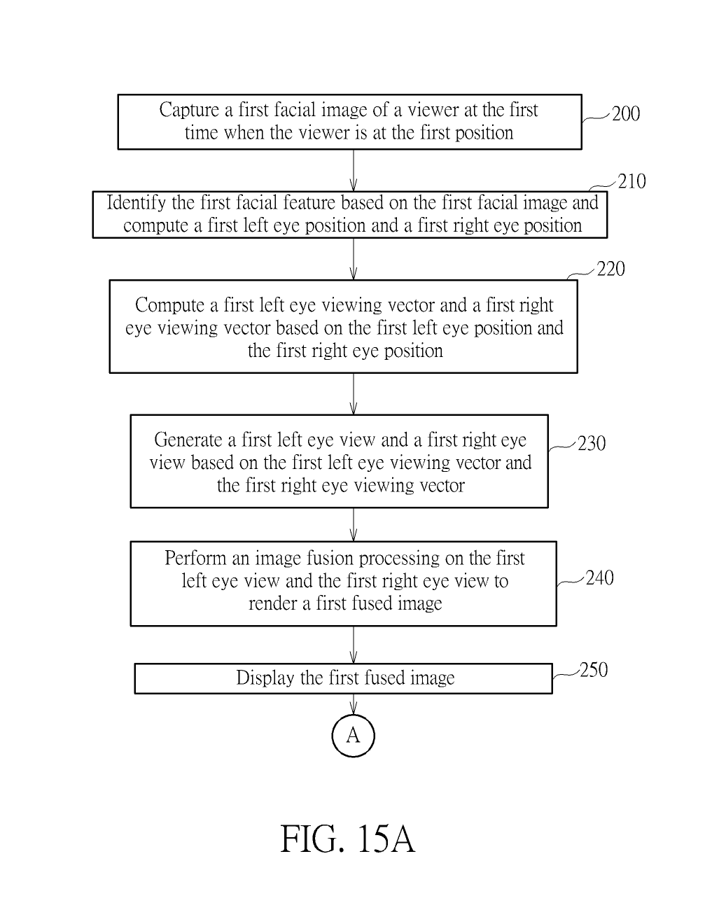

In some other embodiments, various display information could be selectively displayed on the display device corresponding to the viewer's sightline. FIGS. 14A-14C are schematic diagrams of three displayed images displayed by a display system according to different sightlines of the viewer. In this embodiment, the display device is a digital vehicle instrument cluster of an intelligent car. For instance, when a driver is at a first position (e.g., the driver's sightline is aligned at the center of the digital vehicle instrument cluster), the displayed image observed by the driver is shown in FIG. 14A. Specifically, the displayed image includes a speedometer showing a current speed of the intelligent car in the middle section, a tachometer showing a rotation speed of the engine of the intelligent car on the left of the speedometer, and an odometer showing the distance travelled by the intelligent car on the right of the speedometer.

Afterward, at a second time, when the driver shifts the sightline to the left (e.g., the driver moves his/her head to the right and looks towards the left), the displayed image is changed, for example, a temperature information is displayed on the left section of the digital vehicle instrument cluster, as shown in FIG. 14B. Alternatively, at a third time, when the driver shifts the sightline to the right (e.g., the driver moves his/her head to the left and looks towards the right), the displayed image is changed, for example, a fuel gauge indicating the amount of fuel is shown on the right section of the digital vehicle instrument cluster.

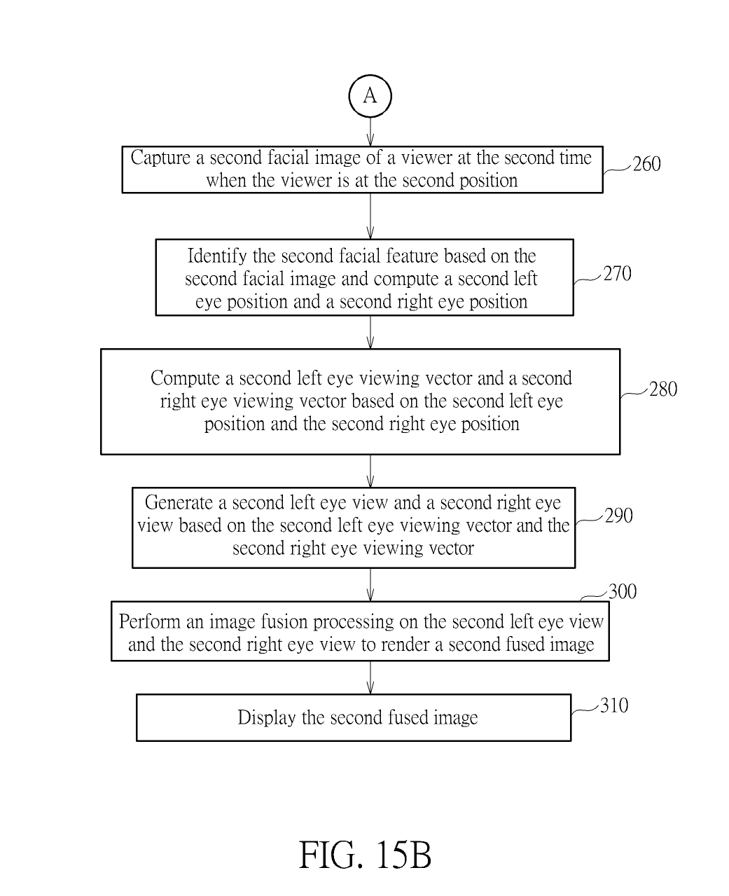

As such, the method for displaying images on a display system according to different sightlines of the viewer is provided. FIGS. 15A and 15B are flowcharts of a method for displaying images on a display system according to the second embodiment of the present disclosure. The method includes the following actions.

In action 200, a first facial image 5 of the viewer is captured by an image capturing module 31 at the first time when the viewer is at the first position 1000.

In action 210, a first facial feature 50 is identified, by the processing unit 33, based on the first facial image 5 and a first left eye position 501 and a first right eye position 502 are computed.

In action 220, a first left eye viewing vector 401 and a first right eye viewing vector 402 are computed, by the processing unit 33, based on the first left eye position 501 and the first right eye position 502.

In action 230, a first left eye view 41 and a first right eye view 42 are generated, by the processing unit 33, based on the first left eye viewing vector 401 and the first right eye viewing vector 402, respectively; where the first left eye view 41 and the first right eye view 42 overlap with each other to form an first overlapping region 43, the first left eye view 41 includes a first left graphic information of the object 4, and the first right eye view 42 includes a first right graphic information of the object 4.

In action 240, an image fusion processing is performed, by the processing unit 33, on the first left eye view 41 and the first right eye view 42 to render a first fused image 7.

In action 250, the first fused image 7 is displayed on the display device 32 when the viewer is at the first position 1000.

In action 260, a second facial image 6 of the viewer is captured by an image capturing module 31 at the second time when the viewer is at the second position 2000.

In action 270, a second facial feature 60 is identified, by the processing unit 33, based on the second facial image 6, and a second left eye position 601 and the second right eye position 602.

In action 280, a second left eye viewing vector 405 and a second right eye viewing vector 406 are computed, by the processing unit 33, based on the second left eye position 601 and the second right eye position 602.

In action 290, a second left eye view 45 and a second right eye view 46 are generated, by the processing unit 33, based on the second left eye viewing vector 405 and the second right eye viewing vector 406, respectively; where the second left eye view 45 and the second right eye view 46 overlap with each other to form a second overlapping region 47, the second left eye view 41 includes a second left graphic information of the object 4, and the second right eye view 46 includes a second right graphic information of the object 4.

In action 300, the image fusion processing is performed, by the processing unit 33, on the second left eye view 45 and the second right eye view 46 to render the second fused image 8.

In action 310, the second fused image 8 is displayed on the display device 32 when the viewer is at the second position 2000.

In one implementation, the image capturing module 31 captures images at several times and the processing unit 33 calculates the position of the viewer and generates the corresponding image to be displayed. In another implementation, the processing unit 33 detects a motion of the viewer, determines a motion vector (including a distance and a direction of the motion) when the motion of the viewer is detected, and then adjusts the first fused image in response to the motion vector. For instance, instead of performing actions 260-310, when the processing unit 33 detects that the viewer moves 10 cm to the right, the processing unit 33 adjust the first fused image by shifting 10 cm to the right. It is noted that the projection between the viewer's motion and the variation of the fused image may not be 1:1 projection.

In some implementations, the processing unit 33 tracks a gaze of the viewer, determines a gaze vector (including a variation of a distance and a direction of the gaze) when the gaze of the viewer is moved, and then adjusts the first fused image in response to the gaze vector. For instance, instead of performing actions 260-310, when the processing unit 33 detects that the gaze of the viewer is changed, the processing unit 33 calculates the gaze vector, and then adjust the first fused image accordingly.

In the above embodiments, the object 4 is set as the origin of the coordinate system. However, in some other embodiments, there are multiple objects/items/information to be displayed, and each one maybe selectively displayed according to the sightlines of the viewer. In this case, the origin of the coordinate system may be set at a center of the virtual space 49 so that the left/right eye vectors of the viewer at the first position 1000 and the second position 2000 can be conveniently computed.

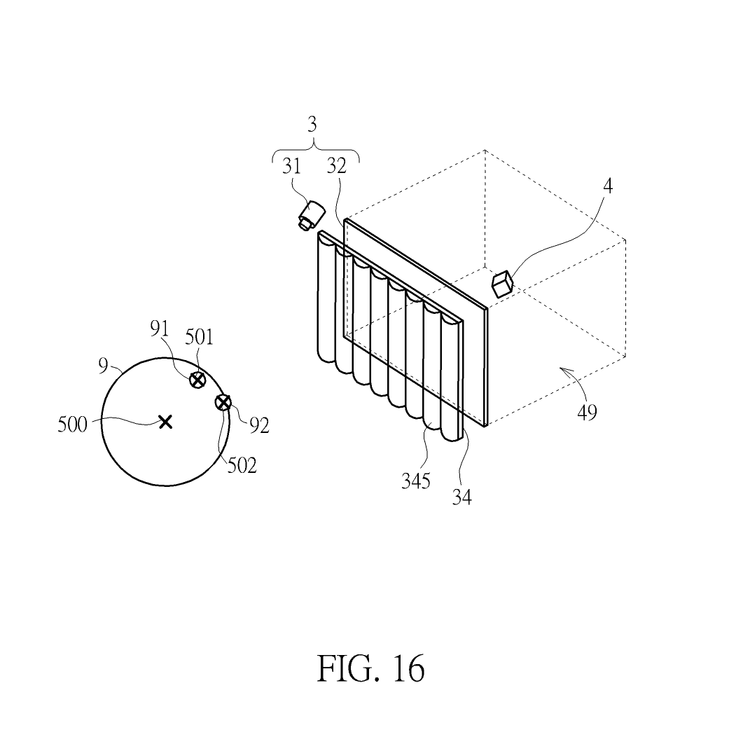

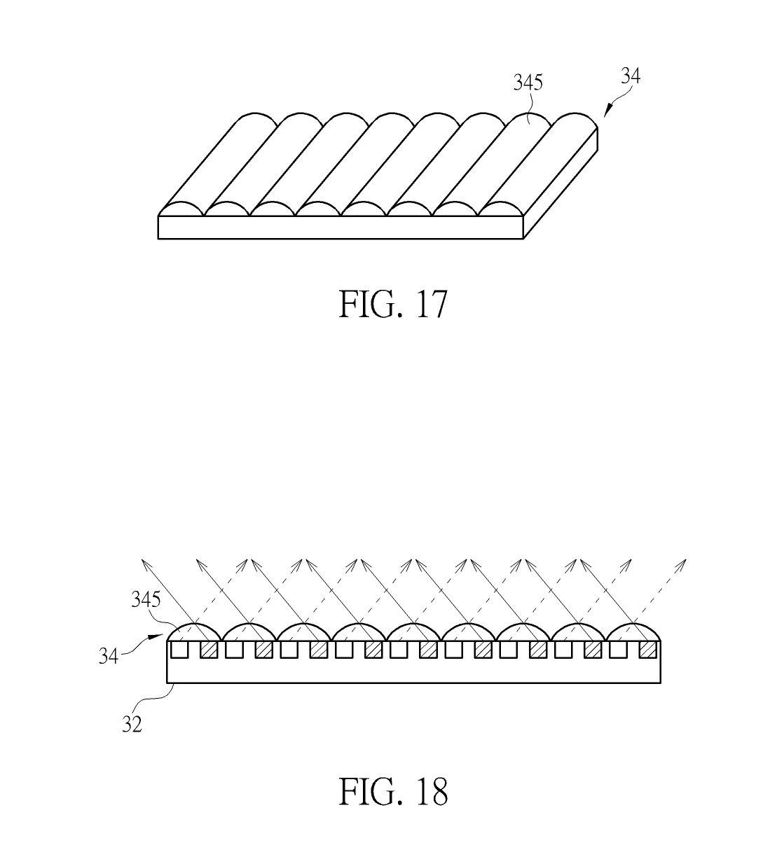

In the present disclosure, another display system and method are described as follows with reference to FIGS. 16-19. FIG. 16 is a schematic diagram of the display system according to the third embodiment of a present disclosure. As shown in FIG. 16, the display system further a lens module 34 disposed on the display device 32. Via the lens module 34, the present disclosure provides an autostereoscopic display to display the stereoscopic fused image to the viewer. FIG. 17 is a schematic diagram of a lens module 34 according to the third embodiment of the present disclosure. As shown in FIG. 17, the lens module 34 includes a plurality of lenticular lens 345. It should be noticed that, in another embodiment, instead of the lens module 34, other devices having a similar function, such as a thin film may be disposed on the display device 32.

FIG. 18 is a schematic diagram illustrating a projection of an interlaced fused image via the lens module 34 according to the third embodiment of the present disclosure. As shown in FIG. 18, Via the lens module, a first part of the fused image (a1) is refracted into the left eye of the viewer, and a second part of the image (a2) is refracted into the right eye of the viewer.

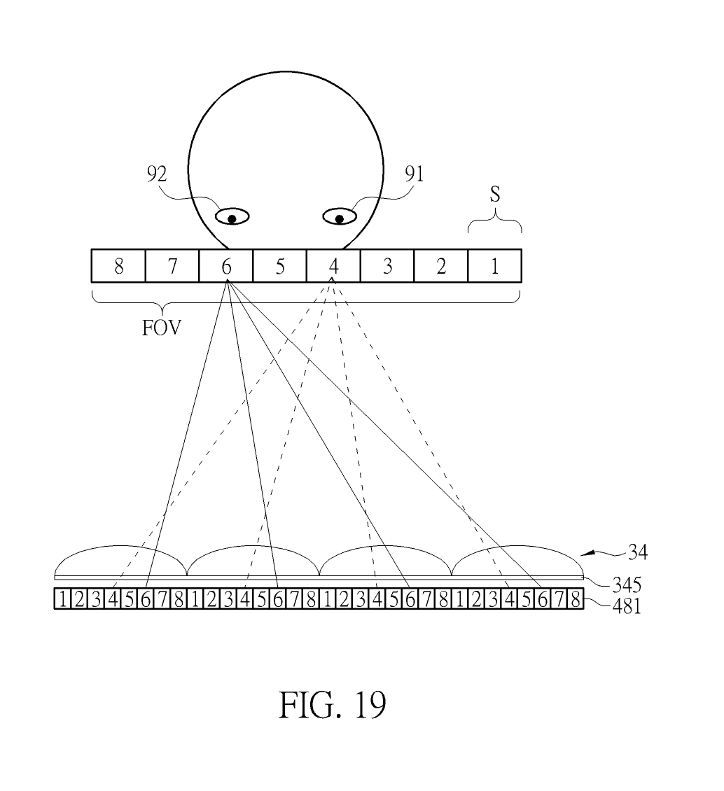

Please refer to FIG. 19. FIG. 19 is a schematic diagram illustrating an implementation of a projection of the interlaced fused image via the lens module 34 according to the third embodiment of the present disclosure. In this implementation, a viewing zone of the viewer (e.g., the location of the viewer's eyes) may be equally divided into N regions, where N is a positive integer greater than 1. For instance, the viewing zone of the viewer is equally divided into 8 regions. Accordingly, in order to present an autostereoscopic image, the fused image is divided into 8 subsets. Each subset of the fused image includes multiple uniformly spaced images 481. As shown in FIG. 19, the viewer's left eye 91 falls within the first region denoted as “4”, a first subset of the fused image denoted as “4” is projected to the viewer's left eye via the lens module 34. Similarly, the viewer's right eye 92 falls within the second region denoted as “6”, a second subset of the fused image denoted as “6” is projected to the viewer's right eye via the lens module 34. Due to the parallax between the left and right eyes, the first subset of the fused image denoted as “4” observed by the left eye 91 and the second subset of the fused image denoted as “6” observed by the right eye 92 interlace with each other to form a 3D autostereoscopic image.

Furthermore, the 3D autostereoscopic image may vary when the viewer changes the sightline. For example, when the viewer is at the second position 2000, the processing unit 33 renders the second fused image 8. The processing unit 33 divides the second fused image 8 into M subsets, where M is a positive integer greater than 1, and each subset of the fused image includes multiple uniformly spaced images. In this implementation, M is 8. When the viewer is at the second position 2000, and the viewer's left eye 91 is determined to fall within a third region denoted as “3”, a first subset of the second fused image denoted as “3” is projected to the viewer's left eye via the lens module 34. Similarly, the viewer's right eye 92 falls within a fourth region denoted as “5”, a second subset of the second fused image denoted as “5” is projected to the viewer's right eye via the lens module 34. Due to the parallax between the left and right eyes, the first subset of the second fused image denoted as “3” observed by the left eye 91 and the second subset of the second fused image denoted as “5” observed by the right eye 92 interlace with each other to form a 3D autostereoscopic image.

When the viewer shifts from the first position 1000 to the second position 2000, the images displayed by the display device 32 may vary with the viewer's sightline, which provides the viewer with a more realistic visual experience.

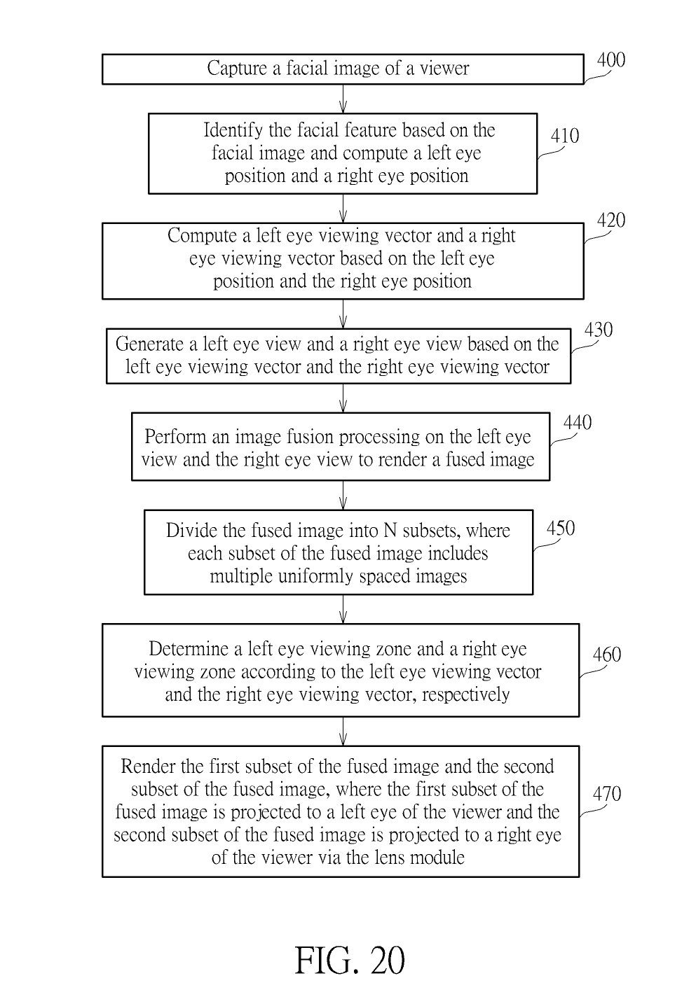

FIG. 20 is a flowchart of a method for displaying images on the display system according to the third embodiment of the present disclosure. in this embodiment, the display system 3 includes an image capturing module 31, a display device 32, a processing unit 33 and a lens module 34. The lens module 34 is disposed between the display device 32 and the viewer, and the lens module 34 includes multiple lenticular lens 345. The method of this embodiment includes the following actions.

In action 400, a facial image 5 is captured by the image capturing module 31.

In action 410, a facial feature 50 is identified, by the processing unit 33, based on the facial image 5 and a left eye position 501 and a right eye position 502 are computed.

In action 420, a left eye viewing vector 401 and a right eye viewing vector 402 are computed, by the processing unit 33, based on the left eye position 501 and the right eye position 502.

In action 430, a left eye view 41 and a right eye view 42 are generated, by the processing unit 33, based on the left eye viewing vector 401 and the right eye viewing vector 402, respectively; where the left eye view 41 includes a left graphic information of the object 4, the right eye view 42 includes a right graphic information of the object 4, and the left eye view 41 and the right eye view 42 overlap with each other to form the overlapping region 43.

In action 440, an image fusion processing is performed, by the processing unit 33, on the left eye view 41 and the right eye view 42 to render a fused image 7.

In action 450, the fused image 7 is divided, by the processing unit 33, into N subsets. Each subset of the fused image 7 includes a plurality of uniformly spaced images.

In action 460, a left eye viewing zone and a right eye viewing zone is determined, by the processing unit 33, according to the left eye viewing vector 401 and the right eye viewing vector 402, respectively.

In action 470, a first subset of the fused image and a second subset of the fused image are rendered by the processing unit 33, where the first subset of the fused image 7 is projected to a left eye of the viewer via the lens module 34, and the second subset of the fused image 7 is projected to a right eye of the viewer via the lens module 34.

Besides the abovementioned facial features computation and image fusion processing, the image capturing module may further include a processor for performing image processing, such as High-dynamic-range (HDR) imaging, adjust the depth of field. In some other embodiments, the image capturing module transmits raw image data to the processing unit 33 to compute parameters, such as angle, distance or depth of field for rendering images.

The display system and method for displaying images of the present disclosure display images corresponding to the sightlines of the viewer, which provides the viewer with a more realistic visual effect similar to the real-life experience that the viewer observes any objects. Besides, since the displayed images varies with different sightlines of the viewer, more data contents of the object may be selectively displayed within a limited size or range of the display device, and thus the range of vision of the viewer may be extended substantially.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stereoscopic image display system, comprising:
an image capturing module configured to capture a facial image of a viewer;
a processing unit coupled to the image capturing module, the processing unit being configured to perform:
identifying a facial feature based on the facial image and computing a left eye position and a right eye position;
computing a left eye viewing vector and a right eye viewing vector based on the left eye position and the right eye position, respectively;
generating a left eye view and a right eye view based on the left eye viewing vector and the right eye viewing vector, respectively; and
performing image fusion processing on the left eye view and the right eye view to render a fused image; and
a display device coupled to the processing unit and comprising a lens module, wherein the fused image is projected to a left eye of the viewer and a right eye of the viewer via the lens module.

2. The stereoscopic image display system of claim 1, wherein the lens module comprises a plurality of lenticular lens, and the processing unit is further configured to perform:
determining a left eye viewing zone according to the left eye viewing vector;
determining a right eye viewing zone according to the right eye viewing vector;
dividing the fused image into N subsets, wherein N is a positive integer greater than 1, and each subset of the first fused image includes a plurality of uniformly spaced images;
rendering a first subset of the fused image according to the first left eye viewing zone; and
rendering a second subset of the fused image according to the first right eye viewing zone;
wherein the first subset of the fused image is projected to the left eye of the viewer via the lens module, and the second subset of the fused image is projected to the right eye of the viewer via the lens module.

3. The stereoscopic image display system of claim 1, wherein a part of the fused image projected to the left eye of the viewer is interlaced with a part of the fused image projected to the right eye of the viewer to form a stereoscopic fused image.

4. The stereoscopic image display system of claim 1, wherein the processing unit is further configured to perform:
establishing a coordinate system for displaying the fused image;
obtaining a position of the image capturing module and a position of the viewer;
computing a left eye position vector and a right eye position vector based on the position of the viewer, the left eye position and the right eye position;
computing the left eye viewing vector based on the position of the image capturing module and the left eye position vector; and
computing the right eye vector viewing based on the position of the image capturing module and the right eye position vector.

5. The stereoscopic image display system of claim 4, wherein the origin of the coordinate system is a displayed object or a center point of a virtual space.

6. The stereoscopic image display system of claim 1, wherein the processing unit is further configured to perform:
rendering the left eye view based on the left eye viewing vector and a field of view of the viewer; and
rendering the right eye view based on the right eye viewing vector and the field of view of the viewer.

7. The stereoscopic image display system of claim 1, wherein the left eye view comprises left graphic information, the right eye view comprises right graphic information, and the fused image comprises the left graphic information and the right graphic information.

8. A stereoscopic image display system, comprising:
an image capturing module configured to capture a first facial image of a viewer at a first time and capture a second facial image of the viewer at a second time;
a processing unit coupled to the image capturing module and configured to perform:
identifying a first facial feature based on the first facial image and computing a first left eye position and a first right eye position;
computing a first left eye viewing vector and a first right eye viewing vector based on the first left eye position and the first right eye position, respectively;
generating a first left eye view and a first right eye view based on the first left eye viewing vector and the first right eye viewing vector, respectively;
performing image fusion processing on the first left eye view and the first right eye view to render a first fused image;
identifying a second facial feature based on the second facial image and computing a second left eye position and a second right eye position;
computing a second left eye viewing vector and a second right eye viewing vector based on the second left eye position and the second right eye position, respectively;
generating a second left eye view and a second right eye view based on the second left eye viewing vector and the second right eye viewing vector, respectively; and
performing the image fusion processing on the second left eye view and the second right eye view to render a second fused image; and
a display device coupled to the processing unit and comprising a lens module;
wherein the first fused image is projected to a left eye and a right eye of the viewer via the lens module at the first time, and the second fused image is projected to the left eye and the right eye of the viewer via the lens module at the second time.

9. The stereoscopic image display system of claim 8, wherein the lens module comprises a plurality of lenticular lens, the processing unit is further configured to perform:
determining a first left eye viewing zone according to the first left eye viewing vector;
determining a first right eye viewing zone according to the first right eye viewing vector;
determining a second left eye viewing zone according to the second left eye viewing vector;
determining a second right eye viewing zone according to the second right eye viewing vector;
dividing the first fused image into N subsets and dividing the second fused image into N subsets, wherein N is a positive integer greater than 1, and each subset of the first fused image and the second fused image includes a plurality of uniformly spaced images;
rendering a first subset of the first fused image according to the first left eye viewing zone;
rendering a second subset of the first fused image according to the first right eye viewing zone;
rendering a first subset of the second fused image according to the second left eye viewing zone; and
rendering a second subset of the second fused image according to the second right eye viewing zone;
wherein, at the first time, the first subset of the first fused image is projected to the left eye of the viewer via the lens module, and the second subset of the first fused image is projected to the right eye of the viewer via the lens module; and at the second time, the first subset of the second fused image is projected to the left eye of the viewer via the lens module, and the second subset of the second fused image is projected to the right eye of the viewer via the lens module.

10. The stereoscopic image display system of claim 8, wherein a part of the first fused image projected to the left eye of the viewer is interlaced with a part of the first fused image projected to the right eye of the viewer to form a stereoscopic first fused image, and a part of the second fused image projected to the left eye of the viewer is interlaced with a part of the second fused image projected to the right eye of the viewer to form a stereoscopic second fused image.

11. The stereoscopic image display system of claim 8, wherein the processing unit is further configured to perform:
establishing a coordinate system for displaying the first fused image and the second fused image;
obtaining a position of the image capturing module and a first position of the viewer at the first time and a second position of the viewer at the second time;
computing a first left eye position vector and a first right eye position vector based on the first position, the first left eye position and the first right eye position;
computing the first left eye viewing vector based on the position of the image capturing module and the first left eye position vector;
computing the first right eye viewing vector based on the position of the image capturing module and the first right eye position vector;
computing a second left eye position vector and a second right eye position vector based on the second position, the second left eye position and the second right eye position;
computing the second left eye viewing vector based on the position of the image capturing module and the second left eye position vector; and
computing the second right eye viewing vector based on the position of the image capturing module and the second right eye position vector.

12. The stereoscopic image display system of claim 11, wherein the origin of the coordinate system is a displayed object or a center point of a virtual space.

13. The stereoscopic image display system of claim 8, wherein the processing unit is further configured to perform:
rendering the first left eye view based on the first left eye viewing vector and a field of view of the viewer;
rendering the first right eye view based on the right eye viewing vector and the field of view of the viewer;
rendering the second left eye view based on the second left eye viewing vector and the field of view of the viewer; and
rendering the second right eye view based on the second right eye viewing vector and the field of view of the viewer.

14. The stereoscopic image display system of claim 8, wherein the first left eye view comprises first left graphic information, the first right eye view comprises first right graphic information, the first fused image comprises the first left graphic information and the first right graphic information, the second left eye view comprises second left graphic information, the second right eye view comprises second right graphic information, and the second fused image comprises the second left graphic information and the second right graphic information.

15. A method for displaying stereoscopic images, comprising:
capturing a first facial image of a viewer at a first time;
identifying a facial feature based on the facial image and computing a first left eye position and a first right eye position;
computing a first left eye viewing vector and a first right eye viewing vector based on the first left eye position and the first right eye position, respectively;
generating a first left eye view based on the first left eye viewing vector;
generating a first right eye view based on the first right eye viewing vector;
performing image fusion processing on the first left eye view and the first right eye view to render a first fused image; and
projecting the first fused image to a left eye and a right eye of the viewer via a lens module at the first time.

16. The method of claim 15, further comprising:
expanding a field of view of the viewer along the first left eye viewing vector to render the first left eye view;
expanding the field of view of the viewer along the first right eye viewing vector to render the first right eye view;
wherein the first left eye view comprises first left graphic information, the first right eye view comprises first right graphic information, and the first fused image comprises the first left graphic information and the first right graphic information.

17. The method of claim 15, further comprising:
determining a first left eye viewing zone according to the first left eye viewing vector;
determining a first right eye viewing zone according to the first right eye viewing vector;
dividing the first fused image into N subsets, wherein N is a positive integer greater than 1, and each subset of the first fused image includes a plurality of uniformly spaced images;
rendering a first subset of the first fused image according to the first left eye viewing zone; and
rendering a second subset of the first fused image according to the first right eye viewing zone;
wherein, at the first time, the first subset of the first fused image is projected to the left eye of the viewer via the lens module, the second subset of the first fused image is projected to the right eye of the viewer via the lens module, and the first subset of the first fused image is interlaced with the second subset of the first fused image to form a stereoscopic first fused image.

18. The method of claim 15, further comprising:
capturing a second face image of the viewer at a second time;
identifying a facial feature based on the face image and computing a second left eye position and a second right eye position;
computing a second left eye viewing vector and a second right eye viewing vector based on the second left eye position and the second right eye position, respectively;
generating a second left eye view and a second right eye view based on the second left eye viewing vector and the second right eye viewing vector, respectively;
performing the image fusion processing on the second left eye view and the second right eye view to render a second fused image; and
refracting the second fused image to the left eye and the right eye of the viewer via the lens at the second time.

19. The method of claim 17, further comprising:
determining a second left eye viewing zone according to the second left eye viewing vector;
determining a second right eye viewing zone according to the second right eye viewing vector;
dividing the second fused image into N subsets, wherein each subset of the second fused image includes a plurality of uniformly spaced images;
rendering a first subset of the second fused image according to the second left eye viewing zone; and
rendering a second subset of the second fused image according to the second right eye viewing zone;
wherein, at the second time, the first subset of the second fused image is projected to the left eye of the viewer via the lens module, the second subset of the second fused image is projected to the right eye of the viewer via the lens module, and the first subset of the second fused image is interlaced with the second subset of the second fused image to form a stereoscopic second fused image.

20. The method of claim 17, further comprising:
expanding a field of view of the viewer along the second left eye viewing vector to render the second left eye view;
expanding the field of view of the viewer along the second right eye viewing vector to render the second right eye view;
wherein the second left eye view comprises second left graphic information, the second right eye view comprises second right graphic information, and the second fused image comprises the second left graphic information and the second right graphic information.
